(19) United States
(12) Patent Application Publication
(10) Pub. No.: US 2026/0030194 A1
(43) Pub. Date: Jan. 29, 2026

(54) VIRTUAL CHANNEL USAGE LIMIT COORDINATION

(71) Applicant: Intel Corporation, Santa Clara, CA (US)

(72) Inventors: Mohannad Fahim Ali, San Jose, CA (US); Swadesh Choudhary, Mountain View, CA (US); Debendra Das Sharma, Saratoga, CA (US)

(73) Assignee: Intel Corporation, Santa Clara, CA (US)

(21) Appl. No.: 19/342,124

(22) Filed: Sep. 26, 2025

Related U.S. Application Data
(60) Provisional application No. 63/807,536, filed on May 16, 2025.

(51) Int. Cl. G06F 13/42

(52) U.S. Cl. CPC G06F 13/4221; G06F 2213/0026

(57) ABSTRACT

A device includes a port to couple to another device over an interconnect, where the port includes circuitry to: identify a receiver usage limit for a given virtual channel of a link to be implemented on the interconnect; generate a link layer packet, where the link layer packet includes a field to indicate the receiver usage limit; and send the link layer packet to the other device over the link.

### RELATED APPLICATIONS

This application claims benefit to U.S. Provisional Patent Application Ser. No. 63/807,536, filed May 16, 2025, which is incorporated by reference herein in its entirety.

### BACKGROUND

Advances in semi-conductor processing and logic design have permitted an increase in the amount of logic that may be present on integrated circuit devices. As a corollary, computer system configurations have evolved from a single or multiple integrated circuits in a system to multiple cores, multiple hardware threads, and multiple logical processors present on individual integrated circuits, as well as other interfaces integrated within such processors. A processor or integrated circuit typically comprises a single physical processor die, where the processor die may include any number of cores, hardware threads, logical processors, interfaces, memory, controller hubs, etc. As the processing power grows along with the number of devices in a computing system, the communication between sockets and other devices becomes more critical. Accordingly, interconnects, have grown from more traditional multi-drop buses that primarily handled electrical communications to full blown interconnect architectures that facilitate fast communication. Unfortunately, as the demand for future processors to consume at even higher-rates corresponding demand is placed on the capabilities of existing interconnect architectures. Interconnect architectures may be based on a variety of technologies, including Peripheral Component Interconnect Express (PCIe), Universal Serial Bus, and others.

### BRIEF DESCRIPTION OF THE DRAWINGS

FIG. 1 illustrates an embodiment of a computing system including an interconnect architecture.

FIG. 2 illustrates an embodiment of an interconnect architecture including a layered stack.

FIG. 3 illustrates an embodiment of a request or packet to be generated or received within an interconnect architecture.

FIG. 4 illustrates an embodiment of a transmitter and receiver pair for an interconnect architecture.

FIG. 5 illustrates a first device coupled to a second device by an example link.

FIG. 6 illustrates an example data link layer packet format for delivering over-the-link usage limit information.

FIG. 7 illustrates another example data link layer packet format for delivering over-the-link usage limit information.

FIG. 8 illustrates an example virtual channel resource capability register.

FIG. 9 illustrates an example virtual channel resource control register.

FIG. 10 illustrates an example virtual channel resource status register.

FIG. 11 illustrates an embodiment of a block diagram for a computing system including a multicore processor.

FIG. 12 illustrates another embodiment of a block diagram for a computing system.

### DETAILED DESCRIPTION

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present disclosure. It will be apparent, however, to one skilled in the art that these specific details need not be employed to practice the principles and solutions discussed in this disclosure. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present disclosure.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems and may be also used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus′, methods, and systems described herein are not limited to physical computing devices, but may also relate to software optimizations for energy conservation and efficiency.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it's a singular purpose of most fabrics to provide highest possible performance with maximum power saving. Below, a number of interconnects are discussed, which would potentially benefit from aspects of the solutions described herein.

One interconnect fabric architecture includes the Peripheral Component Interconnect (PCI) Express (PCIe) architecture. A primary goal of PCIe is to enable components and devices from different vendors to inter-operate in an open architecture, spanning multiple market segments; Clients (Desktops and Mobile), Servers (Standard and Enterprise), and Embedded and Communication devices. PCI Express is a high performance, general purpose I/O interconnect defined for a wide variety of future computing and communication platforms. Some PCI attributes, such as its usage model, load-store architecture, and software interfaces, have been maintained through its revisions, whereas previous parallel bus implementations have been replaced by a highly scalable, fully serial interface. The more recent versions of PCI Express take advantage of advances in point-to-point interconnects, Switch-based technology, and packetized protocol to deliver new levels of performance and features. Power Management, Quality Of Service (QoS), Hot-Plug/Hot-Swap support, Data Integrity, and Error Handling are among some of the advanced features supported by PCI Express.

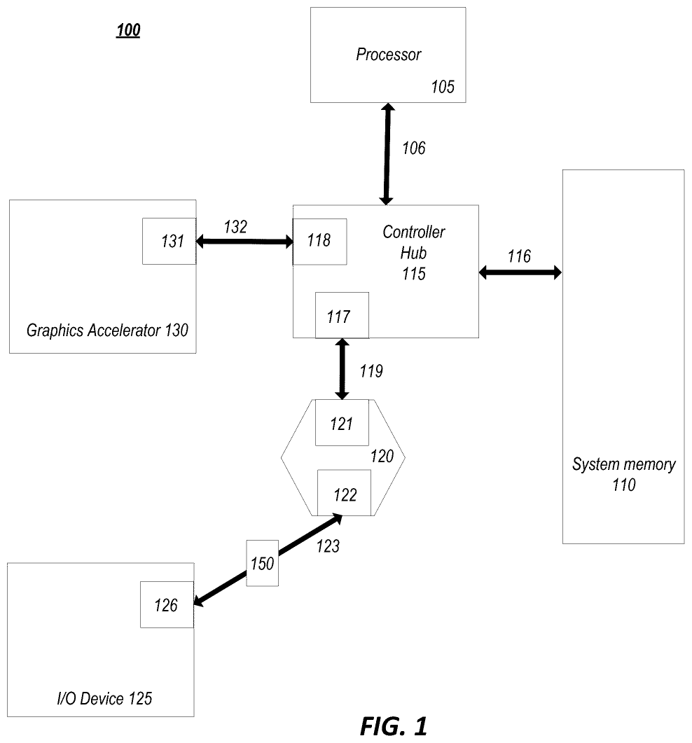

Referring to FIG. 1, an embodiment of a fabric composed of point-to-point Links that interconnect a set of components is illustrated. System 100 includes processor 105 and system memory 110 coupled to controller hub 115. Processor 105 includes any processing element, such as a microprocessor, a host processor, an embedded processor, a co-processor, or other processor. Processor 105 is coupled to controller hub 115 through front-side bus (FSB) 106. In one embodiment, FSB 106 is a serial point-to-point interconnect as described below. In another embodiment, link 106 includes a serial, differential interconnect architecture that is compliant with different interconnect standard.

System memory 110 includes any memory device, such as random access memory (RAM), non-volatile (NV) memory, solid state memory, or other memory accessible by devices in system 100. System memory 110 is coupled to controller hub 115 through memory interface 116. Examples of a memory interface include a double-data rate (DDR) memory interface, a dual-channel DDR memory interface, and a dynamic RAM (DRAM) memory interface.

In one embodiment, controller hub 115 is a root hub, root complex, or root controller in a Peripheral Component Interconnect Express (PCIe or PCIE) interconnection hierarchy. Examples of controller hub 115 include a chipset, a memory controller hub (MCH), a northbridge, an interconnect controller hub (ICH) a southbridge, and a root controller/hub. Often the term chipset refers to two physically separate controller hubs, i.e. a memory controller hub (MCH) coupled to an interconnect controller hub (ICH). Note that current systems often include the MCH integrated with processor 105, while controller 115 is to communicate with I/O devices, in a similar manner as described below. In some embodiments, peer-to-peer routing is optionally supported through root complex 115.

Here, controller hub 115 is coupled to switch/bridge 120 through serial link 119. Input/output modules 117 and 121, which may also be referred to as interfaces/ports 117 and 121, include/implement a layered protocol stack to provide communication between controller hub 115 and switch 120. In one embodiment, multiple devices are capable of being coupled to switch 120.

Switch/bridge 120 routes packets/messages from device 125 upstream, i.e. up a hierarchy towards a root complex, to controller hub 115 and downstream, i.e. down a hierarchy away from a root controller, from processor 105 or system memory 110 to device 125. Switch 120, in one embodiment, is referred to as a logical assembly of multiple virtual PCI-to-PCI bridge devices. Device 125 includes any internal or external device or component to be coupled to an electronic system, such as an I/O device, a Network Interface Controller (NIC), an add-in card, an audio processor, a network processor, a hard-drive, a storage device, a CD/DVD ROM, a monitor, a printer, a mouse, a keyboard, a router, a portable storage device, a Firewire device, a Universal Serial Bus (USB) device, a scanner, and other input/output devices. Often in the PCIe vernacular, such as device, is referred to as an endpoint. Although not specifically shown, device 125 may include a PCIe to PCI/PCI-X bridge to support legacy or other version PCI devices. Endpoint devices in PCIe are often classified as legacy, PCIe, or root complex integrated endpoints.

Graphics accelerator 130 is also coupled to controller hub 115 through serial link 132. In one embodiment, graphics accelerator 130 is coupled to an MCH, which is coupled to an ICH. Switch 120, and accordingly I/O device 125, is then coupled to the ICH. I/O modules 131 and 118 are also to implement a layered protocol stack to communicate between graphics accelerator 130 and controller hub 115. Similar to the MCH discussion above, a graphics controller or the graphics accelerator 130 itself may be integrated in processor 105. It should be appreciated that one or more of the components (e.g., 105, 110, 115, 120, 125, 130) illustrated in FIG. 1 can be enhanced to execute, store, and/or embody logic to implement one or more of the features described herein.

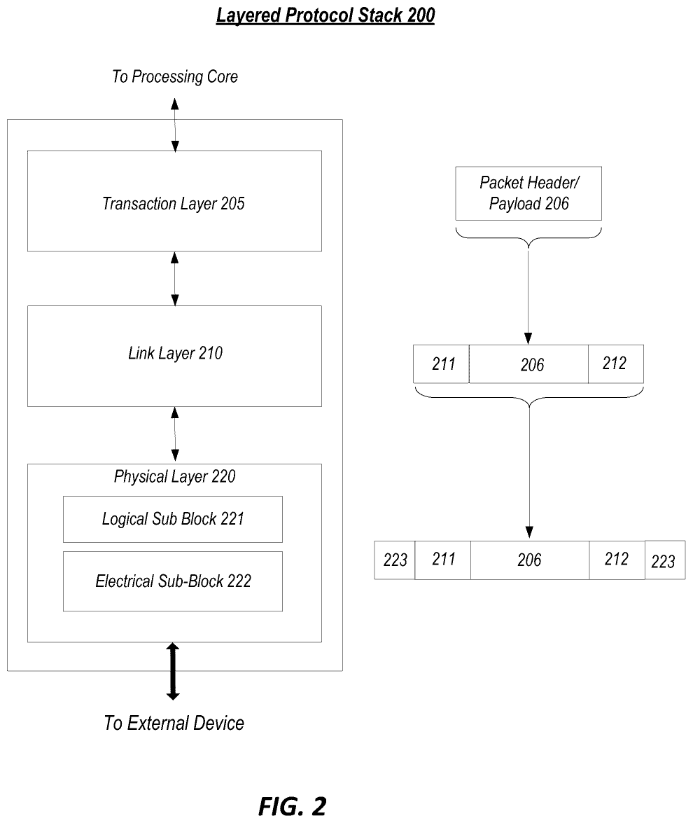

Turning to FIG. 2 an embodiment of a layered protocol stack is illustrated. Layered protocol stack 200 includes any form of a layered communication stack, such as a Quick Path Interconnect (QPI) stack, a PCIe stack, a next generation high performance computing interconnect stack, or other layered stack. Although the discussion immediately below in reference to FIGS. 1-4 are in relation to a PCIe stack, the same concepts may be applied to other interconnect stacks. In one embodiment, protocol stack 200 is a PCIe protocol stack including transaction layer 205, link layer 210, and physical layer 220. An interface, such as interfaces 117, 118, 121, 122, 126, and 131 in FIG. 1, may be represented as communication protocol stack 200. Representation as a communication protocol stack may also be referred to as a module or interface implementing/including a protocol stack.

PCI Express uses packets to communicate information between components. Packets are formed in the Transaction Layer 205 and Data Link Layer 210 to carry the information from the transmitting component to the receiving component. As the transmitted packets flow through the other layers, they are extended with additional information necessary to handle packets at those layers. At the receiving side the reverse process occurs and packets get transformed from their Physical Layer 220 representation to the Data Link Layer 210 representation and finally (for Transaction Layer Packets) to the form that can be processed by the Transaction Layer 205 of the receiving device.

### Transaction Layer

In one embodiment, transaction layer 205 is to provide an interface between a device's processing core and the interconnect architecture, such as data link layer 210 and physical layer 220. In this regard, a primary responsibility of the transaction layer 205 is the assembly and disassembly of packets (i.e., transaction layer packets, or TLPs). The translation layer 205 typically manages credit-based flow control for TLPs. PCIe implements split transactions, i.e. transactions with request and response separated by time, allowing a link to carry other traffic while the target device gathers data for the response.

In addition PCIe utilizes credit-based flow control. In this scheme, a device advertises an initial amount of credit for each of the receive buffers in Transaction Layer 205. An external device at the opposite end of the link, such as controller hub 115 in FIG. 1, counts the number of credits consumed by each TLP. A transaction may be transmitted if the transaction does not exceed a credit limit. Upon receiving a response an amount of credit is restored. An advantage of a credit scheme is that the latency of credit return does not affect performance, provided that the credit limit is not encountered.

In one embodiment, four transaction address spaces include a configuration address space, a memory address space, an input/output address space, and a message address space. Memory space transactions include one or more of read requests and write requests to transfer data to/from a memory-mapped location. In one embodiment, memory space transactions are capable of using two different address formats, e.g., a short address format, such as a 32-bit address, or a long address format, such as 64-bit address. Configuration space transactions are used to access configuration space of the PCIe devices. Transactions to the configuration space include read requests and write requests. Message transactions are defined to support in-band communication between PCIe agents.

Therefore, in one embodiment, transaction layer 205 assembles packet header/payload 156. Format for current packet headers/payloads may be found in the PCIe specification at the PCIe specification website.

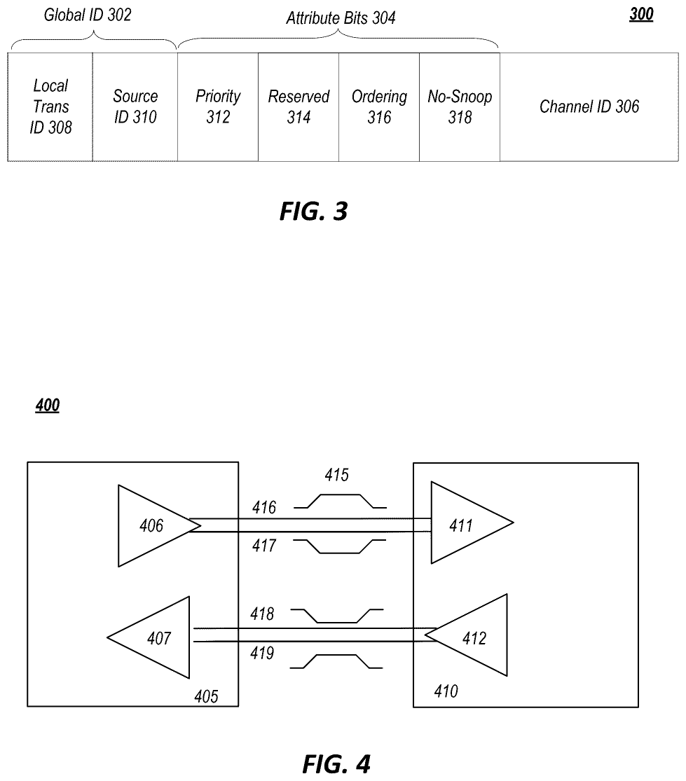

Quickly referring to FIG. 3, an embodiment of a PCIe transaction descriptor is illustrated. In one embodiment, transaction descriptor 300 is a mechanism for carrying transaction information. In this regard, transaction descriptor 300 supports identification of transactions in a system. Other potential uses include tracking modifications of default transaction ordering and association of transaction with channels.

Transaction descriptor 300 includes global identifier field 302, attributes field 304 and channel identifier field 306. In the illustrated example, global identifier field 302 is depicted comprising local transaction identifier field 308 and source identifier field 310. In one embodiment, global transaction identifier 302 is unique for all outstanding requests.

According to one implementation, local transaction identifier field 308 is a field generated by a requesting agent, and it is unique for all outstanding requests that require a completion for that requesting agent. Furthermore, in this example, source identifier 310 uniquely identifies the requestor agent within a PCIe hierarchy. Accordingly, together with source ID 310, local transaction identifier 308 field provides global identification of a transaction within a hierarchy domain.

Attributes field 304 specifies characteristics and relationships of the transaction. In this regard, attributes field 304 is potentially used to provide additional information that allows modification of the default handling of transactions. In one embodiment, attributes field 304 includes priority field 312, reserved field 314, ordering field 316, and no-snoop field 318. Here, priority sub-field 312 may be modified by an initiator to assign a priority to the transaction. Reserved attribute field 314 is left reserved for future, or vendor-defined usage. Possible usage models using priority or security attributes may be implemented using the reserved attribute field.

In this example, ordering attribute field 316 is used to supply optional information conveying the type of ordering that may modify default ordering rules. According to one example implementation, an ordering attribute of “0” denotes default ordering rules are to apply, wherein an ordering attribute of “1” denotes relaxed ordering, wherein writes can pass writes in the same direction, and read completions can pass writes in the same direction. Snoop attribute field 318 is utilized to determine if transactions are snooped. As shown, channel ID Field 306 identifies a channel that a transaction is associated with.

### Link Layer

Link layer 210, also referred to as data link layer 210, acts as an intermediate stage between transaction layer 205 and the physical layer 220. In one embodiment, a responsibility of the data link layer 210 is providing a reliable mechanism for exchanging Transaction Layer Packets (TLPs) between two components a link. One side of the Data Link Layer 210 accepts TLPs assembled by the Transaction Layer 205, applies packet sequence identifier 211, i.e. an identification number or packet number, calculates and applies an error detection code, i.e. CRC 212, and submits the modified TLPs to the Physical Layer 220 for transmission across a physical to an external device.

### Physical Layer

In one embodiment, physical layer 220 includes logical sub block 221 and electrical sub-block 222 to physically transmit a packet to an external device. Here, logical sub-block 221 is responsible for the “digital” functions of Physical Layer 221. In this regard, the logical sub-block includes a transmit section to prepare outgoing information for transmission by physical sub-block 222, and a receiver section to identify and prepare received information before passing it to the Link Layer 210.

Physical block 222 includes a transmitter and a receiver. The transmitter is supplied by logical sub-block 221 with symbols, which the transmitter serializes and transmits onto to an external device. The receiver is supplied with serialized symbols from an external device and transforms the received signals into a bit-stream. The bit-stream is de-serialized and supplied to logical sub-block 221. In one embodiment, an 8 b/10 b transmission code is employed, where ten-bit symbols are transmitted/received. Here, special symbols are used to frame a packet with frames 223. In addition, in one example, the receiver also provides a symbol clock recovered from the incoming serial stream.

As stated above, although transaction layer 205, link layer 210, and physical layer 220 are discussed in reference to a specific embodiment of a PCIe protocol stack, a layered protocol stack is not so limited. In fact, any layered protocol may be included/implemented. As an example, an port/interface that is represented as a layered protocol includes: (1) a first layer to assemble packets, i.e. a transaction layer; a second layer to sequence packets, i.e. a link layer; and a third layer to transmit the packets, i.e. a physical layer. As a specific example, a common standard interface (CSI) layered protocol is utilized.

Referring next to FIG. 4, an embodiment of a PCIe serial point to point fabric is illustrated. Although an embodiment of a PCIe serial point-to-point link is illustrated, a serial point-to-point link is not so limited, as it includes any transmission path for transmitting serial data. In the embodiment shown, a basic PCIe link includes two, low-voltage, differentially driven signal pairs: a transmit pair 406/412 and a receive pair 411/407. Accordingly, device 405 includes transmission logic 406 to transmit data to device 410 and receiving logic 407 to receive data from device 410. In other words, two transmitting paths, i.e. paths 416 and 417, and two receiving paths, i.e. paths 418 and 419, are included in a PCIe link.

A transmission path refers to any path for transmitting data, such as a transmission line, a copper line, an optical line, a wireless communication channel, an infrared communication link, or other communication path. A connection between two devices, such as device 405 and device 410, is referred to as a link, such as link 415. A link may support one lane—each lane representing a set of differential signal pairs (one pair for transmission, one pair for reception). To scale bandwidth, a link may aggregate multiple lanes denoted by xN, where N is any supported Link width, such as 1, 2, 4, 8, 12, 16, 32, 64, or wider. In some implementations, each symmetric lane contains one transmit differential pair and one receive differential pair. Asymmetric lanes can contain unequal ratios of transmit and receive pairs. Some technologies can utilize symmetric lanes (e.g., PCIe), while others (e.g., Displayport) may not and may even including only transmit or only receive pairs, among other examples.

A differential pair refers to two transmission paths, such as lines 416 and 417, to transmit differential signals. As an example, when line 416 toggles from a low voltage level to a high voltage level, i.e. a rising edge, line 417 drives from a high logic level to a low logic level, i.e. a falling edge. Differential signals potentially demonstrate better electrical characteristics, such as better signal integrity, i.e. cross-coupling, voltage overshoot/undershoot, ringing, etc. This allows for better timing window, which enables faster transmission frequencies.

In PCIe, rapid advancements are taking place as the protocol evolves from generation 4.0 to generations 5.0 and 6.0. PCIe 4.0 may support 16 lane links with effective bandwidths of 64 GB/s and extended support for retimers and other features. PCIe 5.0 maintains the 16 lane link width, while doubling the effective bandwidth to 128 GB/s. To maintain these advances in bandwidth, PCIe 6.0 preserves the 16 lane link and adopts pulse amplitude modulation (PAM) encoding (e.g., PAM4 encoding), as opposed to PCIe's traditional non-return-to-zero (NRZ) encoding (e.g., 8 b/10 b, 128 b/130 b), to increase the number of bits that may be sent on a serial channel within a single unit interval (UI). Accordingly, PCIe 6.0 further doubles bandwidth to 64 GT/s from 32 GT/s in PCIe 5.0 thereby enabling 256 GB/s of bidirectional bandwidth. Such links may be valuably applied to couple devices such as a deep learning and artificial intelligence hardware accelerator devices; high speed graphic processor units, tensor processor units, and other deep learning processors; high-speed memory; and other hardware in a variety of emerging computing applications, from deep learning applications, autonomous vehicles, robotics, and high performance memory architectures, among other examples. PCIe 6.0 further includes low-latency Forward Error Correction (FEC) and other features to improve bandwidth efficiency, while maintaining backward compatibility with previous PCIe generations and similar channel reach to what is available in PCIe 5.0.

While high-speed PAM4 encoding allows links to realize new and improved applications, such links may be more susceptible to errors. In some implementations, a link and corresponding protocol may be configured to operate in multiple modes, such as a flit mode when high-speed PAM4 encoding is utilized and another (e.g., non-flit) mode when lower speed encoding (e.g., 8 b/10 b, 128 b/130 b NRZ) is used. For instance, a higher speed mode may utilize and particularly benefit from Forward Error Correction. Accordingly, a flit mode may be implemented, which subdivides the transmission of a single packet into a set of one or more defined flow control units, or “flits,” at the data link or logical PHY layer. However, such features may complicate parsing of the packet at the receiver. Each flit may include a respective header with information corresponding to the flit and packet, allowing some information traditionally reserved for the packet header to be omitted when redundant. In some implementations, two (or more) separate packet header formats may be defined for an interconnect (e.g., for PCIe 6.0-based interconnects), where a first packet header format is utilized for a mode utilizing flits for the packet transfer, and a different, second packet header format is utilized for a mode that does not utilize flits (e.g., a legacy mode defined in the protocol), among other example implementations. In some implementations it may be desirable to utilize flits for packet transfer when operating in lower speed modes (e.g., 8 b/10 b, 128 b/130 b NRZ).

In the case of PCIe, the transaction layer packet (TLP) header structure has evolved slowly but remained mostly unchanged. With the adoption of PAM4 encoding and a shift to flit-based data integrity with PCIe 6.0, a new, revised TLP header format may be utilized. The new, flit-mode TLP header may also address the reality that existing PCIe TLP headers lacks remaining reserved bits to expand the features and information, which may be communicated in corresponding packet header fields. In one example implementations, a flit-mode TLP header may replace the traditional, orthogonal, Format (Fmt) and Type fields to a fully-decoded 8-bit TLP Type field, which may be encoded with values to indicate all (or considerably all) existing TLP Types in PCIe, while adding new TLP types for no-op (NOP) and End Bad (EDB) packets types. Indeed, with flit mode, any number of NOP TLPs may be transmitted before or after any other TLP, with NOP TLPs discarded without effect by the receiver. Further the flit-mode TLP header may add new expanded header elements to include what had previously been communicated using TLP Prefixes and other mechanisms in PCIe, including Process Address Space Identifier (PASID), TLP Processing Hints, and Secure TLPs, among other examples. Other example modifications may include the addition of an 8-bit Segment ID (SBDF) to Requester and Completer ID, increasing the Tag field bits (e.g., 12, 14, or 16 bits), removing outdated fields and elements (e.g., the “Byte Count” field), among other example modifications.

Among the example benefits, which may be realized through a flit-mode packet header, the header may provide the ability for the receiver's transaction layer to robustly parse incoming TLP content without relying on TLP demarcation information from the Physical or Data Link Layers. As another example, extensibility of packets may be better facilitated via a flexible TLP structure consisting of a TLP Header Base followed by flexibly added additional header content (e.g., zero to 7 additional double words (DW) of content). In one example, the PCIe Transaction Digest may be replaced in flit mode packets by a “Trailer” of zero to 3 DW. In some implementations, the first DW of the Header Base includes all information requisite to determine the full size of the TLP, including the Header itself, any data payload, and the Trailer, if present. The End Bad (EDB) and Poisoned TLP mechanisms may also be modified, and in flit mode indicated via Suffixes which, if present, immediately follow the TLP to which they apply, and which, for Poisoned, are conveyed end-to-end with the TLP through Root Complexes that support peer-to-peer and all switches. Further, all TLP Type encodings defined for flit mode headers may be assigned flow control and routing for “forwards compatibility,” such that new opcodes can be allocated without requiring modification to existing switch and the generic blocks of PCIe controller hardware.

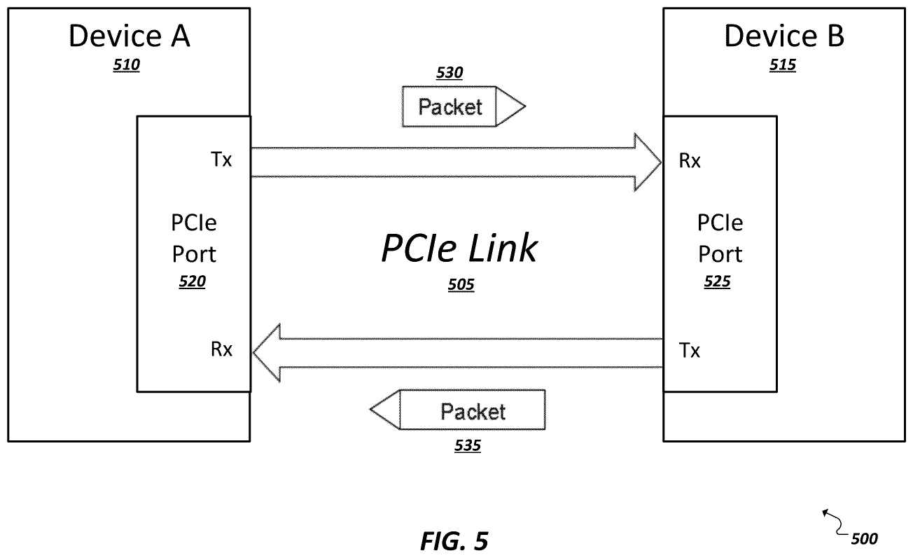

Turning to FIG. 5, a simplified block diagram 500 is shown illustrating an example PCIe link 505 coupling a first device 510 to a second device 515. Each of the devices 510, 515 may be equipped with one or more multiple ports (e.g., 520, 525) to support one or more multiple connections to other devices (e.g., on the same or different die or package). The port (e.g., 520, 525) may include transmit and receive circuitry as well as logic (e.g., implemented in hardware circuitry) to implement one or more interconnect protocols governing operation of a corresponding connection. For instance, ports 520, 525 may each include circuitry to implement a layered protocol stack of a PCIe-based protocol. The PCIe protocol (e.g., PCIe 6.0, PCIe 7.0, etc.) may support both a flit mode and another non-flit mode. The corresponding protocol circuitry (e.g., of ports 520, 525) may be utilized to generate packets (e.g., 530, 535) with packet headers according to each of the flit mode and non-flit mode, such as discussed in the examples herein. Likewise, protocol logic at the devices 510, 515 (e.g., corresponding to the receivers of the ports 520, 525) may receive packets (e.g., 530, 535) generated and sent by another device and utilize information within the packets to identify boundaries of the packet and parse the packet and its contents (e.g., using fields such as discussed in the examples below).

In high-speed communication protocols like PCIe, efficient resource allocation across multiple Virtual Channels (VCs) may be crucial to maintaining optimal performance. Some standards that support shared receiver resources, such as PCIe, have mechanisms for software to apply per-VC usage limits at the transmitter to control the maximum number of shared resources each VC may consume. However, current specifications do not provide standardized mechanisms for a receiver to communicate its ideal resource usage limits to the transmitter, for instance, through software or directly over the communication link, which can hinder real-time quality of service adjustments. This is significant for multi-VC usages where each VC has different latency profiles and/or the receiver supports different bandwidths. Additionally, these existing mechanisms for managing shared resources often lack the flexibility to dynamically adjust usage limits once channels are enabled or if usage limits are already enforced. These limitations are particularly problematic as traffic received on different VCs can experience different latency profiles, such as when directed to different memory locations, or where traffic is to be processed at different speeds due to packet attributes and/or ordering requirements, or due to topology factors, among other examples. These issues can lead to resource contention and suboptimal throughput, as a slower VC that is not constrained appropriately may consume more of the shared resources and affect overall link throughput (e.g., potentially starving other VCs of the shared resources). Some default VCs, such as VCO, may be automatically enabled by hardware during link initialization, leaving no opportunity for software to set usage limits before they become active. This issue becomes particularly problematic with the introduction of traffic types like Unordered I/O (UIO), which is delivered on VCs that are enabled by software after link initialization, among other example issues.

In traditional systems, the system may implement a proprietary algorithm or protocol for throttling a given VC, but no standardized approaches are currently defined. As an example, for dynamically updating limits for non-VCO virtual channels, the traditional approach involves disabling and re-enabling the channel, a process that is both time-consuming and resource intensive. This approach is not practical for real-time adjustments (e.g., while the link is up and active (e.g., in an L0 state)) and can lead to suboptimal performance, especially in environments where traffic patterns are dynamic and require tuning. In an improved implementation, an enhanced protocol may be implemented that facilitates the dynamic updating of usage limits for various Virtual Channels (VC) on the link, enabling real-time adjustments as channels are enabled or as workloads change. Protocol logic within the system may allow a receiver on a channel to make its ideal usage limits visible to software and to communicate these limits directly to the transmitter over the communication link, thus eliminating the need for software intervention and accommodating varying latencies and processing speeds for different VCs. The transmitter uses the more restrictive of the usage limits communicated over the link and any programmed usage limits when calculating effective limits on the amount of shared resources that may be consumed by each VC. Such features may enhance the flexibility and efficiency of PCIe and derivative protocols by allowing real-time adjustments to flow control limits, thereby optimizing link throughput and resource allocation. Further, such protocol enhancement may enable the support of different rates for UIO and non-UIO usages (as well as other multi-VC applications) and have a capability to advertise for proper configurability, among other example features and advantages.

In one example implementations, to streamline the communication of usage limits, the receiver can transmit an over-the-link packet to the transmitter. This packet may be enhanced to include fields for use in coordinating VC usage limits. As an example, the packet may include a usage limit enable flag and the usage limit value for a targeted one of the virtual channels (VCs) on the link, allowing the transmitter to consume the usage limit information within the packet to autonomously adjust the transmitter behavior without software intervention. This may allow the link partners to update shared credit usage limits when a given VC (or collection of VCs) is already enabled (e.g., and the link is operating in an active or L0 state) or when usage limits are already enabled, allowing for usage limits to be adjusted without disabling the VC or clearing existing limits. Further, supporting registers (e.g., control and status registers) may be defined and may be populated with corresponding information (e.g., by the receiver or the transmitter) to make the usage limits for various VC to be visible to software (e.g., to allow software to use adjust system configurations appropriately for hardware that may not support the enhanced packet).

In one example, a port supporting PCIe Flit Mode (or another interconnect protocol utilizing flit-based data transfers) may utilize a shared flow control (FC) mechanism to reduce VC resource requirements. There may be two sets of resources associated with each of the VCs supported for a link: (1) a pool of dedicated resources (e.g., comparatively small to a shared resource pool) associated independently with corresponding respective FC/VC combinations (e.g., to avoid deadlock by allowing a transmitter to transmit at least one TLP in that VC/FC using only dedicated credit(s)), and (2) a portion of the pool of shared resources. In some implementations, a transmitter gate function may use the sum of all Shared FC returned across all VCs. The transmitter gate function may also provide a Usage Limit mechanism to avoid over-consumption of buffers by stalled VCs. This Usage Limit mechanism may be configured by software and may default to disabled. Usage limits, as discussed herein, may also be defined between link partners using packets (e.g., data link layer packets (DLLPs)), such as flow control parameter packets (e.g., FCParameters DLLPs). In connection with the Usage Limit features, a link partner may return credits to an associated Transmitter indicating the VC for the TLP(s) that, by making forward progress, freed those credits.

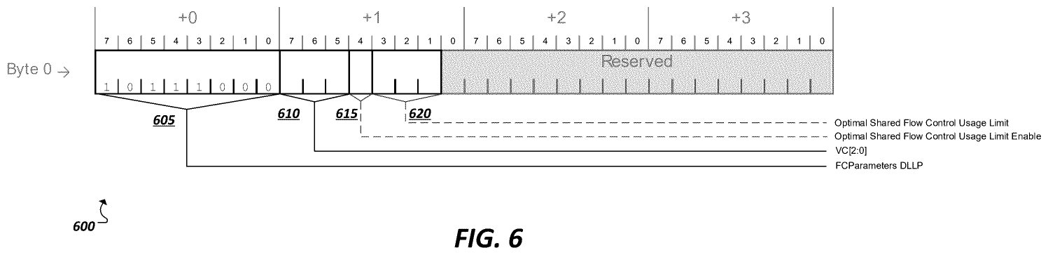

For instance, FIG. 6 illustrates an example format for a PCIe Data Link Layer Packet (DLLP) 600 (e.g., FCParameters DLLP) that may be used to deliver usage limit information, such as where dynamic setting of usage limits is supported. For instance, the packet 600 may include fields to indicate (e.g., at 605) that the DLPP is a flow control (FC) parameters DLLP, an identifier 610 of the corresponding target VC, an enable bit 615 to indicate whether usage limit enforcement should be enabled for the VC, and a field 620 to identify the usage limit of the receiver. For instance, the field 620 indicating the usage limit may be encoded with a value to specify the maximum allowable shared credit consumption for the VC (e.g., expressed as a percentage). Table 1 indicates a listing of example encodings for usage values (e.g., a 100% value may be communicated by setting Usage Limit Enable to Ob).

TABLE 1
Example Usage Limit Encodings and Values

| Encoding [2:0] | Value |
|---|---|
| 000b | 0% |
| 001b | 12.5% |
| 010b | 25% |
| 011b | 37.5% |
| 100b | 50% |
| 101b | 62.5% |
| 110b | 75% |
| 111b | 87.5% |

By transmitting this packet, the receiver may aim to ensure that the transmitter is promptly informed of the desired usage limits, enabling real-time hardware autonomous adjustments and optimal resource allocation. In some protocols, there may already be controls on the transmitter side that allow software to set or apply usage limits. In such cases, transmitters should use the more restrictive or conservative value between the over-the-link usage limit provided by the receiver and any existing control mechanisms set by the software. This ensures that the transmitter operates within the most stringent constraints, optimizing resource allocation and maintaining system stability.

In one example implementations, for each VC, the determination of the Shared Flow Control Usage Limit applied by the shared transmitter gating function test is to consider the most constrained setting from the following mechanisms: programming through the VC Resource Control Register, and Optimal Shared Flow Control Usage Limit values received through over-the-link DLLP. The Effective Shared Flow Control Usage Limit may refer to the calculated value that results in the smallest percentage of shared flow control credits that the FC/VC may consume, based on the enabled and supported settings from the above mechanisms. All references to Shared Flow Control Usage Limit in equations and text should use this effective value.

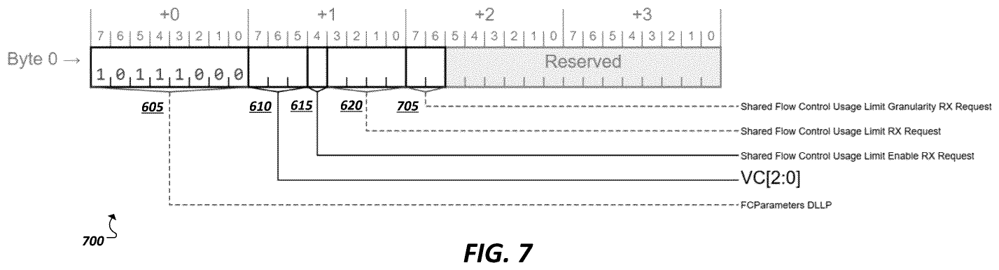

In some implementations, more granular usage limit values (e.g., percentage values) may be desired to be used (e.g., different from or more granular than those in the example of Table 1). For instance, the protocol may support two or more alternative levels of granularity to be applied in usage limit values identified using an example flow control parameter DLLP. As an example, a default set of usage limits may be defined and be expressed as one-eight increments of use (e.g., 12.5% use increments), such as in the example of Table 1. Alternatively, usage limits may be expressed in one-sixteenth increments (e.g., 6.25% increments). In such an example, additional fields or bits may be provided in an example flow control parameter DLLP to enable an alternative usage limit granularity setting. For instance, turning to FIG. 7, another example format 700 for a flow control parameter DLLP (e.g., compliant with a PCIe-based or CXL-based protocol) is illustrated to further include usage limit granularity field 705. For instance, the usage limit granularity field 705 can be populated with an encoding to indicate what level of granularity should apply to the usage limit value. The usage limit granularity field 705 can allow finer granularity adjustments to be made to the percentage of the available Shared Flow Control a given VC is permitted to consume (e.g., to increase the usage control limit granularity by a half or quarter step (e.g., from 12.5% to 18.75%), as opposed to a full step (e.g., from 12.5% to 25.0%)). For instance, an encoding of “10” may indicate that adjustments at 6.25% granularity may be made, among other example implementations. This granularity adjustment may be applied independently for each Flow Control credit type. For example, if usage limit field 620 contains 101b (e.g., to indicate a base limit of 62.5%) and the usage limit granularity field 705 field contains 10b (e.g., to indicate a half-step granularity of 6.25% to be applied to the base limit), a Posted TLP may not pass the Tx Gate if doing so would cause that VC to consume more than 68.75% (62.5%+6.25%) of the available Shared Posted Header credits or if doing so would cause that VC to consume more than 68.75% of the available Shared Data credits, among other examples.

In some implementations, the fields relating to adjusting flow control usage limits (e.g., in a flow control parameter packet) may be set to, or reverted to, reserved fields in the event the dynamic usage limit capability and/or shared flow control usage limits are not support by one or both of the ports. When supported, in some implementations, a flow control parameters DLLP (such as in the examples of FIGS. 6 and 7) is to be transmitted when support for the corresponding capabilities are indicated in a corresponding register of the port (e.g., when a FCParameters Transmit Enable bit is set). The specific trigger condition for transmission of the flow control parameters packet may be defined by the corresponding application or system and may include examples such as the enablement of an additional VC (e.g., UIO) to adjust or rebalance usage limits across the new combination of VCs, another event leading to a rebalancing of channel resources (e.g., detecting overuse or underuse of the shared resources by one or more specific VCs), a stage to a quality of service parameter influencing how VC sharing is allocated, among other examples. In short, a flow control parameters DLLP, when transmitted, signals the desired usage limit settings to the link partner. When received, the link partner may check the DLLP for integrity and if correct, the information content of the DLLP is passed to the corresponding Transaction Layer. If, however, the check fails, the information is discarded.

When configuring the Shared Flow Control Usage Limit field (e.g., 620) and Shared Flow Control Usage Limit Enable field (e.g., 615), it is possible that an associated VC could already be enabled or that usage limit enforcement could already be active. For example, VCO is typically enabled and configured by default by hardware before other VCs get enabled and software has the opportunity to set the usage limit appropriately. In scenarios where the Shared Flow Control Usage Limit Enable field 615 is set or the Shared Flow Control Usage Limit 620 is adjusted while the VC is enabled, there may be transactions in flight with pending credit returns. If the new usage limit imposes a more restrictive limit on shared flow control consumption than what has already been consumed, there could be a temporary gap in traffic flow. This gap occurs, for instance, while the credits accumulate enough to drop below the new threshold. There may be no strict requirement on how quickly a new usage limit value should be applied after being requested using a flow control parameters packet. For instance, credit values may be snapshotted at different stages of an implementation's pipeline. It may be beneficial, however, to transition to the new usage limit value as soon as it is safely possible to maintain optimal performance and avoid unnecessary delays in traffic flow. Indeed, ports may include logic to implement smooth transitions without causing disruptions or stalls in traffic (e.g., by enforcing or implementing gradually adjusted credit calculations or managing temporary imbalances in credit consumption (e.g., while the link remains in an active transmitting mode in some instances).

For interoperability with transmitters that do not support the identification of over-the-link usage limit updates and for complex switching topologies, the receiver may also be equipped with a register interface that allows it to advertise its desired usage limits for each VC. This interface includes a recommended enable flag and usage limit value for each VC, which can be accessed by software to configure the transmitter's behavior. In one example, the register structure may include a VC Usage Limit Register, which includes an Enable Flag and a Usage Limit Value. The Enable Flag may be implemented as a binary flag indicating whether usage limit enforcement should be enabled for the VC. The register's Usage Limit Value may be implemented as an integer value specifying the maximum allowable shared credit consumption for the VC. Table 1 shows a listing of examples encodings and values to be used in the register's identification of usage limits. A 100% value may be communicated by setting Usage Limit Enable to Ob. This register interface provides a software-visible mechanism for the receiver to communicate its resource allocation preferences.

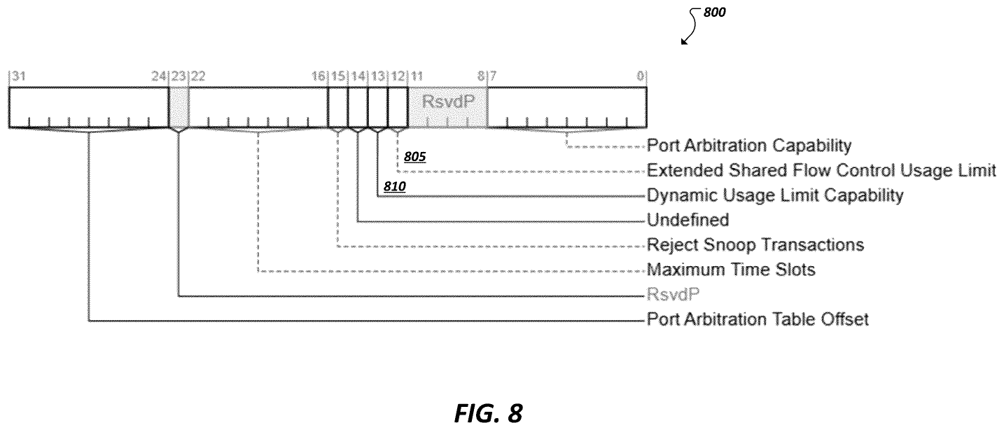

Additionally, in some implementations, one or more status and capability registers may be defined and maintained (and accessible to system software) to indicate whether and to what extent a given port supports dynamic usage limit value adjustments and/or flow control parameters packets used to communicate usage limit values, such as discussed above. For instance, FIG. 8 shows an example VC resource capability register 800 with at least one register field to indicate capabilities supported for a given VC, such as a Extended Shared Flow Control Usage Limit field 805, which when set, indicates extended support of shared flow control usage limit encodings, and a Dynamic Usage Limit Capability field 810, which when set, When set, indicates that shared flow control usage limit updates when the VC is enabled or Shared Flow Control Usage Limit Enable is already Set are allowed on this VC. When set, Dynamic Usage Limit Capability field 810 further indicates support for an associated FCParameters DLLP.

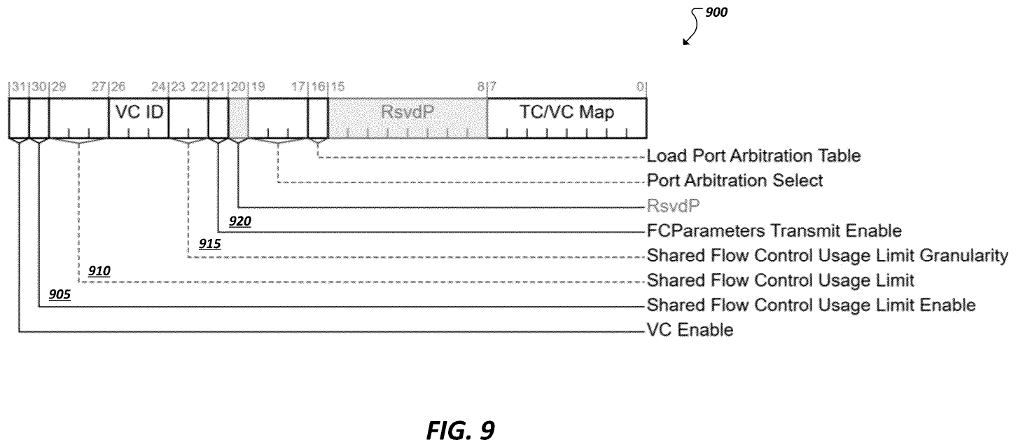

FIG. 9 illustrates an example VC resource control register 900. In this example, various register bits may be dedicated to providing information concerning support of dynamic VC usage limit coordination. For instance, a Shared Flow Control Usage Limit Enable bit 905 when set may enable use of shared flow control usage limits. Shared Flow Control Usage Limit register bits 910 can control the base percentage of the available shared flow control a given FC/VC is permitted to consume, which can be further refined by the Shared Flow Control Usage Limit Granularity field. Accordingly, a Shared Flow Control Usage Limit Granularity field 915 can controls the finer granularity adjustments to the percentage of the available Shared Flow Control a given FC/VC is permitted to consume. This field is added to the value in the Shared Flow Control Usage Limit field to determine the effective shared flow control usage limit. As another example, a FCParameters Transmit Enable bit 920 controls the transmission of the FCParameters DLLP—when set, FCParameters DLLP transmission is enabled, when clear, FCParameters DLLP transmission is disabled for the port.

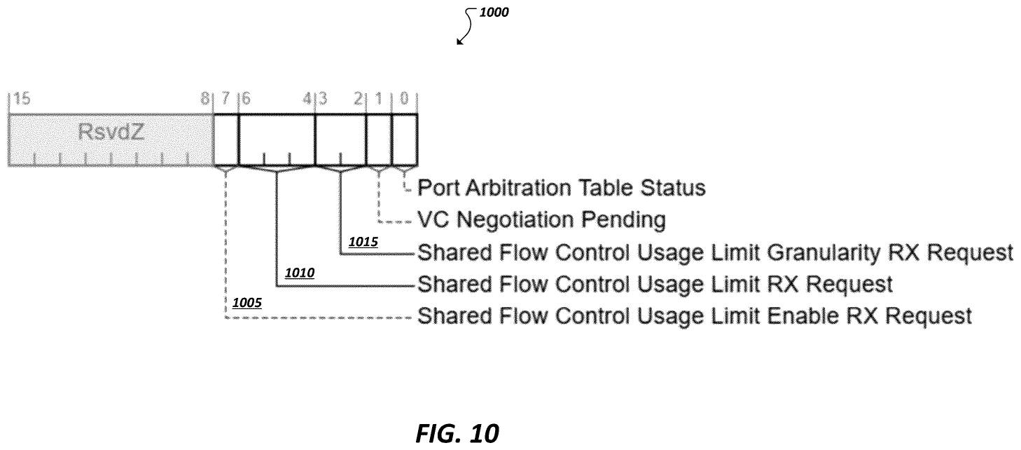

FIG. 10 illustrates an example VC resource status register 1000. In this example FCParameters DLLP. For instance, a Shared Flow Control Usage Limit Enable RX Request bit 1005 may be provided to indicate, when set, that Shared Flow Control Usage Limit enforcement is recommended at the Link partner for the Virtual Channel. A Shared Flow Control Usage Limit RX Request field 1010 may be provided to indicate the recommended base percentage of the available Shared Flow Control the Virtual Channel is permitted to consume at the Link partner (when Shared Flow Control Usage Limit Enable RX Request 1005 is set). Shared Flow Control Usage Limit Granularity RX Request field 1015 may be provided that (when the Shared Flow Control Usage Limit Enable RX Request bit 1005 is set) indicates the recommended finer granularity adjustment to the percentage of the available Shared Flow Control the Virtual Channel is permitted to consume at the Link partner.

In addition to the provision of special DLLPs and other communication techniques, dynamic updates to the usage limits of Virtual Channels (VCs) at the transmitter may be supported, accommodating changes in traffic patterns and channel enablement. The transmitter's behavior is defined for possible scenarios, ensuring efficient resource allocation and adherence to the updated limits. Table 2 outlines examples of the pre-state and post-state for some scenarios, along with the expected behavior.

TABLE 2
Example Dynamic Usage Limit Update Scenarios

| | Current | | Next | |
|---|---|---|---|---|
| Case | VC State | Usage Limit | Usage Limit | Behavior |
| 1 | Disabled | None | Register | Enforce Register |
| | | | | Usage Limits |
| 2 | Enabled | None | Register | Slow down traffic |
| | | | | if exceed limits |
| 3 | Enabled | None | DLLP | Slow down traffic |
| | | | | if exceed limits |
| 4 | Enabled | None | Register, DLLP | Use more restrictive |
| | | | | limits |
| 5 | Enabled | Register | Register, DLLP | Use more restrictive |
| | | (Within Limits) | | limits |
| 6 | Enabled | Any (Within | Higher Limits | Maintain/increase |
| | | Limits) | | injection |
| 7 | Enabled | Any (Exceeds | Lower limits | Reduce injection |
| | | Limits) | | to comply |
| 8 | Enabled | Any (Exceeds | Higher Limits | Resume injection |
| | | Limits) | | within limits |

This dynamic adjustment mechanism ensures that the transmitter can adapt to varying traffic conditions and maintain optimal performance across all VCs. In scenarios where the Shared Flow Control Usage Limit Enable is set or the Shared Flow Control Usage Limit is adjusted while the VC is enabled, there may be transactions in flight with pending credit returns. If the new usage limit imposes a more restrictive limit on Shared Flow Control consumption than what has already been consumed, there could be a temporary gap in traffic flow. This gap occurs while the credits accumulate enough to drop below the new threshold.

While the examples above pertain to PCIe-based protocols, it should be appreciated that these examples are presented to illustrate more generalized principles and features, which may be applied to other interconnect protocols including Compute Express Link (CXL), NVLink, Universal Chiplet Interconnect Express (UCIe), Ultra Path Interconnect (UPI), Infinity Fabric, among other example protocols. Note further that the apparatus′, methods′, and systems described above may be implemented in any electronic device or system as aforementioned. As specific illustrations, the figures below provide exemplary systems for utilizing the concepts as described herein. As the systems below are described in more detail, a number of different interconnects are disclosed, described, and revisited from the discussion above. And as is readily apparent, the advances described above may be applied to any of those interconnects, fabrics, or architectures.

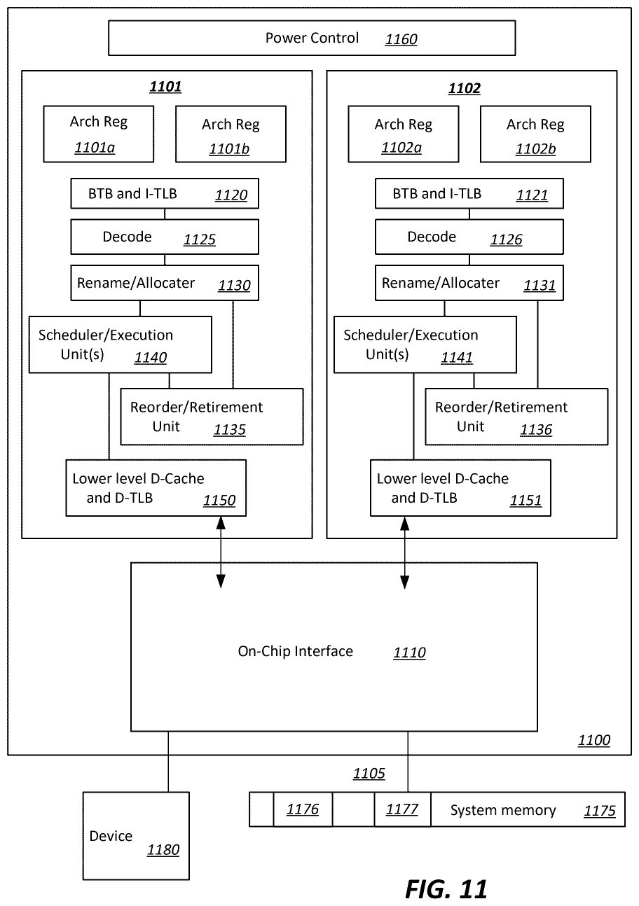

Referring to FIG. 11, an embodiment of a block diagram for a computing system including a multicore processor is depicted. Processor 1100 includes any processor or processing device, such as a microprocessor, an embedded processor, a digital signal processor (DSP), a network processor, a handheld processor, an application processor, a co-processor, a system on a chip (SOC), or other device to execute code. Processor 1100, in one embodiment, includes at least two cores—core 1101 and 1102, which may include asymmetric cores or symmetric cores (the illustrated embodiment). However, processor 1100 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core often refers to logic located on an integrated circuit capable of maintaining an independent architectural state, wherein each independently maintained architectural state is associated with at least some dedicated execution resources. In contrast to cores, a hardware thread typically refers to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical processor 1100, as illustrated in FIG. 11, includes two cores-core 1101 and 1102. Here, core 1101 and 1102 are considered symmetric cores, i.e. cores with the same configurations, functional units, and/or logic. In another embodiment, core 1101 includes an out-of-order processor core, while core 1102 includes an in-order processor core. However, cores 1101 and 1102 may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (i.e. asymmetric cores), some form of translation, such as a binary translation, may be utilized to schedule or execute code on one or both cores. Yet to further the discussion, the functional units illustrated in core 1101 are described in further detail below, as the units in core 1102 operate in a similar manner in the depicted embodiment.

As depicted, core 1101 includes two hardware threads 1101a and 1101b, which may also be referred to as hardware thread slots 1101a and 1101b. Therefore, software entities, such as an operating system, in one embodiment potentially view processor 1100 as four separate processors, i.e., four logical processors or processing elements capable of executing four software threads concurrently. As alluded to above, a first thread is associated with architecture state registers 1101a, a second thread is associated with architecture state registers 1101b, a third thread may be associated with architecture state registers 1102a, and a fourth thread may be associated with architecture state registers 1102b. Here, each of the architecture state registers (e.g., 1101a, 1101b, 1102a, and 1102b) may be referred to as processing elements, thread slots, or thread units, as described above. As illustrated, architecture state registers 1101a are replicated in architecture state registers 1101b, so individual architecture states/contexts are capable of being stored for logical processor 1101a and logical processor 1101b. In core 1101, other smaller resources, such as instruction pointers and renaming logic in allocator and renamer block 1130 may also be replicated for threads 1101a and 1101b. Some resources, such as re-order buffers in reorder/retirement unit 1135, ILTB 1120, load/store buffers, and queues may be shared through partitioning. Other resources, such as general purpose internal registers, page-table base register(s), low-level data-cache and data-TLB 1115, execution unit(s) 1140, and portions of out-of-order unit 1135 are potentially fully shared.

Processor 1100 often includes other resources, which may be fully shared, shared through partitioning, or dedicated by/to processing elements. In FIG. 11, an embodiment of a purely exemplary processor with illustrative logical units/resources of a processor is illustrated. Note that a processor may include, or omit, any of these functional units, as well as include any other known functional units, logic, or firmware not depicted. As illustrated, core 1101 includes a simplified, representative out-of-order (OOO) processor core. But an in-order processor may be utilized in different embodiments. The OOO core includes a branch target buffer 1120 to predict branches to be executed/taken and an instruction-translation buffer (I-TLB) 1120 to store address translation entries for instructions.

Core 1101 further includes decode module 1125 coupled to fetch unit 1120 to decode fetched elements. Fetch logic, in one embodiment, includes individual sequencers associated with thread slots 1101a, 1101b, respectively. Usually core 1101 is associated with a first ISA, which defines/specifies instructions executable on processor 1100. Often machine code instructions that are part of the first ISA include a portion of the instruction (referred to as an opcode), which references/specifies an instruction or operation to be performed. Decode logic 1125 includes circuitry that recognizes these instructions from their opcodes and passes the decoded instructions on in the pipeline for processing as defined by the first ISA. For example, as discussed in more detail below decoders 1125, in one embodiment, include logic designed or adapted to recognize specific instructions, such as transactional instruction. As a result of the recognition by decoders 1125, the architecture or core 1101 takes specific, predefined actions to perform tasks associated with the appropriate instruction. It is important to note that any of the tasks, blocks, operations, and methods described herein may be performed in response to a single or multiple instructions; some of which may be new or old instructions. Note decoders 1126, in one embodiment, recognize the same ISA (or a subset thereof). Alternatively, in a heterogeneous core environment, decoders 1126 recognize a second ISA (either a subset of the first ISA or a distinct ISA).

In one example, allocator and renamer block 1130 includes an allocator to reserve resources, such as register files to store instruction processing results. However, threads 1101a and 1101b are potentially capable of out-of-order execution, where allocator and renamer block 1430 also reserves other resources, such as reorder buffers to track instruction results. Unit 1130 may also include a register renamer to rename program/instruction reference registers to other registers internal to processor 1100. Reorder/retirement unit 1135 includes components, such as the reorder buffers mentioned above, load buffers, and store buffers, to support out-of-order execution and later in-order retirement of instructions executed out-of-order.

Scheduler and execution unit(s) block 1140, in one embodiment, includes a scheduler unit to schedule instructions/operation on execution units. For example, a floating point instruction is scheduled on a port of an execution unit that has an available floating point execution unit. Register files associated with the execution units are also included to store information instruction processing results. Exemplary execution units include a floating point execution unit, an integer execution unit, a jump execution unit, a load execution unit, a store execution unit, and other known execution units.

Lower level data cache and data translation buffer (D-TLB) 1150 are coupled to execution unit(s) 1140. The data cache is to store recently used/operated on elements, such as data operands, which are potentially held in memory coherency states. The D-TLB is to store recent virtual/linear to physical address translations. As a specific example, a processor may include a page table structure to break physical memory into a plurality of virtual pages.

Here, cores 1101 and 1102 share access to higher-level or further-out cache, such as a second level cache associated with on-chip interface 1110. Note that higher-level or further-out refers to cache levels increasing or getting further way from the execution unit(s). In one embodiment, higher-level cache is a last-level data cache-last cache in the memory hierarchy on processor 1100—such as a second or third level data cache. However, higher level cache is not so limited, as it may be associated with or include an instruction cache. A trace cache-a type of instruction cache-instead may be coupled after decoder 1125 to store recently decoded traces. Here, an instruction potentially refers to a macro-instruction (i.e. a general instruction recognized by the decoders), which may decode into a number of micro-instructions (micro-operations).

In the depicted configuration, processor 1100 also includes on-chip interface module 1110. Historically, a memory controller, which is described in more detail below, has been included in a computing system external to processor 1100. In this scenario, on-chip interface 1110 is to communicate with devices external to processor 1100, such as system memory 1175, a chipset (often including a memory controller hub to connect to memory 1175 and an I/O controller hub to connect peripheral devices), a memory controller hub, a northbridge, or other integrated circuit. And in this scenario, bus 1105 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 1175 may be dedicated to processor 1100 or shared with other devices in a system. Common examples of types of memory 1175 include DRAM, SRAM, non-volatile memory (NV memory), and other known storage devices. Note that device 1180 may include a graphic accelerator, processor or card coupled to a memory controller hub, data storage coupled to an I/O controller hub, a wireless transceiver, a flash device, an audio controller, a network controller, or other known device.

Recently however, as more logic and devices are being integrated on a single die, such as SOC, each of these devices may be incorporated on processor 1100. For example, in one embodiment, a memory controller hub is on the same package and/or die with processor 1100. Here, a portion of the core (an on-core portion) 1110 includes one or more controller(s) for interfacing with other devices such as memory 1175 or a graphics device 1180. The configuration including an interconnect and controllers for interfacing with such devices is often referred to as an on-core (or un-core configuration). As an example, on-chip interface 1110 includes a ring interconnect for on-chip communication and a high-speed serial point-to-point link 1105 for off-chip communication. Yet, in the SOC environment, even more devices, such as the network interface, co-processors, memory 1175, graphics processor 1180, and any other known computer devices/interface may be integrated on a single die or integrated circuit to provide small form factor with high functionality and low power consumption.

In one embodiment, processor 1100 is capable of executing a compiler, optimization, and/or translator code 1177 to compile, translate, and/or optimize application code 1176 to support the apparatus and methods described herein or to interface therewith. A compiler often includes a program or set of programs to translate source text/code into target text/code. Usually, compilation of program/application code with a compiler is done in multiple phases and passes to transform hi-level programming language code into low-level machine or assembly language code. Yet, single pass compilers may still be utilized for simple compilation. A compiler may utilize any known compilation techniques and perform any known compiler operations, such as lexical analysis, preprocessing, parsing, semantic analysis, code generation, code transformation, and code optimization.

Larger compilers often include multiple phases, but most often these phases are included within two general phases: (1) a front-end, i.e. generally where syntactic processing, semantic processing, and some transformation/optimization may take place, and (2) a back-end, i.e. generally where analysis, transformations, optimizations, and code generation takes place. Some compilers refer to a middle, which illustrates the blurring of delineation between a front-end and back end of a compiler. As a result, reference to insertion, association, generation, or other operation of a compiler may take place in any of the aforementioned phases or passes, as well as any other known phases or passes of a compiler. As an illustrative example, a compiler potentially inserts operations, calls, functions, etc. in one or more phases of compilation, such as insertion of calls/operations in a front-end phase of compilation and then transformation of the calls/operations into lower-level code during a transformation phase. Note that during dynamic compilation, compiler code or dynamic optimization code may insert such operations/calls, as well as optimize the code for execution during runtime. As a specific illustrative example, binary code (already compiled code) may be dynamically optimized during runtime. Here, the program code may include the dynamic optimization code, the binary code, or a combination thereof.

Similar to a compiler, a translator, such as a binary translator, translates code either statically or dynamically to optimize and/or translate code. Therefore, reference to execution of code, application code, program code, or other software environment may refer to: (1) execution of a compiler program(s), optimization code optimizer, or translator either dynamically or statically, to compile program code, to maintain software structures, to perform other operations, to optimize code, or to translate code; (2) execution of main program code including operations/calls, such as application code that has been optimized/compiled; (3) execution of other program code, such as libraries, associated with the main program code to maintain software structures, to perform other software related operations, or to optimize code; or (4) a combination thereof.

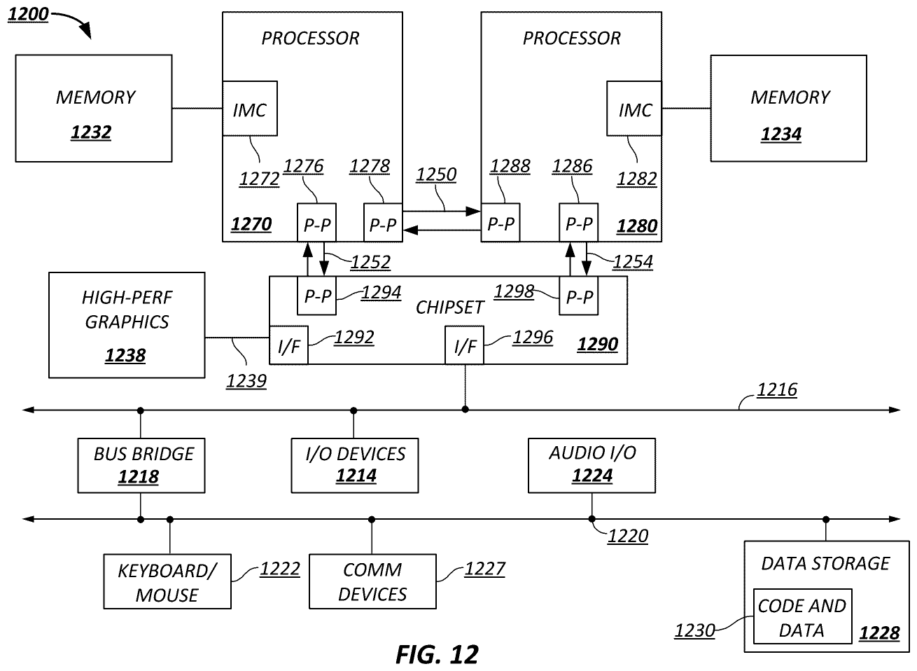

Referring now to FIG. 12, shown is a block diagram of a second system 1200 in accordance with an embodiment of the present disclosure. As shown in FIG. 12, multiprocessor system 1200 is a point-to-point interconnect system, and includes a first processor 1270 and a second processor 1280 coupled via a point-to-point interconnect 1250. Each of processors 1270 and 1280 may be some version of a processor. In one embodiment, 1252 and 1254 are part of a serial, point-to-point coherent interconnect fabric.

While shown with only two processors 1270, 1280, it is to be understood that the scope of the present disclosure is not so limited. In other embodiments, one or more additional processors may be present in a given processor.

Processors 1270 and 1280 are shown including integrated memory controller units 1272 and 1282, respectively. Processor 1270 also includes as part of its bus controller units point-to-point (P-P) interfaces 1276 and 1278; similarly, second processor 1280 includes P-P interfaces 1286 and 1288. Processors 1270, 1280 may exchange information via a point-to-point (P-P) interface 1250 using P-P interface circuits 1278, 1288. As shown in FIG. 12, IMCs 1272 and 1282 couple the processors to respective memories, namely a memory 1232 and a memory 1234, which may be portions of main memory locally attached to the respective processors.

Processors 1270, 1280 each exchange information with a chipset 1290 via individual P-P interfaces 1252, 1254 using point to point interface circuits 1276, 1294, 1286, 1298. Chipset 1290 also exchanges information with a high-performance graphics circuit 1238 via an interface circuit 1292 along a high-performance graphics interconnect 1239.

A shared cache (not shown) may be included in either processor or outside of both processors; yet connected with the processors via P-P interconnect, such that either or both processors' local cache information may be stored in the shared cache if a processor is placed into a low power mode.

Chipset 1290 may be coupled to a first bus 1216 via an interface 1296. In one embodiment, first bus 1216 may be a Peripheral Component Interconnect (PCI) bus, or a bus such as a PCI Express bus or another third generation I/O interconnect bus, although the scope of the present disclosure is not so limited.

As shown in FIG. 12, various I/O devices 1214 are coupled to first bus 1216, along with a bus bridge 1218 which couples first bus 1216 to a second bus 1220. In one embodiment, second bus 1220 includes a low pin count (LPC) bus. Various devices are coupled to second bus 1220 including, for example, a keyboard and/or mouse 1222, communication devices 1227 and a storage unit 1228 such as a disk drive or other mass storage device which often includes instructions/code and data 1230, in one embodiment. Further, an audio I/O 1224 is shown coupled to second bus 1220. Note that other architectures are possible, where the included components and interconnect architectures vary. For example, instead of the point-to-point architecture of FIG. 12, a system may implement a multi-drop bus or other such architecture.

Computing systems can include various combinations of components. These components may be implemented as ICs, portions thereof, discrete electronic devices, or other modules, logic, hardware, software, firmware, or a combination thereof adapted in a computer system, or as components otherwise incorporated within a chassis of the computer system. However, it is to be understood that some of the components shown may be omitted, additional components may be present, and different arrangement of the components shown may occur in other implementations. As a result, the solutions described above may be implemented in any portion of one or more of the interconnects illustrated or described below.

A processor, in one embodiment, includes a microprocessor, multi-core processor, multithreaded processor, an ultra-low voltage processor, an embedded processor, or other known processing element. In the illustrated implementation, processor acts as a main processing unit and central hub for communication with many of the various components of the system. The processor(s) may include any suitable processing unit, such as those based on x86, ARM, RISC-V, or other architectures. Examples include Intel® Core™ processors, AMD Ryzen® or EPYC® processors, Apple® M-series processors, Qualcomm® Snapdragon™ processors, or equivalents. The processor(s) may be part of a system-on-chip (SoC), system-in-package (SiP), or other integrated configurations. Other suitable processors now known or later developed may also be used. Note that many of the customer versions of such processors are modified and varied; however, they may support or recognize a specific instruction set that performs defined algorithms as set forth by the processor licensor. Here, the microarchitectural implementation may vary, but the architectural function of the processor is usually consistent. Certain details regarding the architecture and operation of processor in one implementation will be discussed further below to provide an illustrative example.

Processor, in one embodiment, communicates with a system memory. As an illustrative example, which in an embodiment can be implemented via multiple memory devices to provide for a given amount of system memory. As examples, the memory can be in accordance with a Joint Electron Devices Engineering Council (JEDEC) low power double data rate (LPDDR)-based design such as the current LPDDR2 standard according to JEDEC JESD 209-2E (published April 2009), or a next generation LPDDR standard to be referred to as LPDDR3 or LPDDR4 that will offer extensions to LPDDR2 to increase bandwidth. In various implementations the individual memory devices may be of different package types such as single die package (SDP), dual die package (DDP) or quad die package (13P). These devices, in some embodiments, are directly soldered onto a motherboard to provide a lower profile solution, while in other embodiments the devices are configured as one or more memory modules that in turn couple to the motherboard by a given connector. And of course, other memory implementations are possible such as other types of memory modules, e.g., dual inline memory modules (DIMMs) of different varieties including but not limited to microDIMMs, MiniDIMMs. In a particular illustrative embodiment, memory is sized between 2 GB and 16 GB, and may be configured as a DDR3LM package or an LPDDR2 or LPDDR3 memory that is soldered onto a motherboard via a ball grid array (BGA).

To provide for persistent storage of information such as data, applications, one or more operating systems and so forth, a mass storage may also couple to processor. In various embodiments, to enable a thinner and lighter system design as well as to improve system responsiveness, this mass storage may be implemented via an SSD. However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. A flash device may be coupled to processor, e.g., via a serial peripheral interface (SPI). This flash device may provide for non-volatile storage of system software, including a basic input/output software (BIOS) as well as other firmware of the system.

In various embodiments, mass storage of the system is implemented by an SSD alone or as a disk, optical or other drive with an SSD cache. In some embodiments, the mass storage is implemented as an SSD or as an HDD along with a restore (RST) cache module. In various implementations, the HDD provides for storage of between 320 GB-4 terabytes (TB) and upward while the RST cache is implemented with an SSD having a capacity of 24 GB-256 GB. Note that such SSD cache may be configured as a single level cache (SLC) or multi-level cache (MLC) option to provide an appropriate level of responsiveness. In an SSD-only option, the module may be accommodated in various locations such as in a mSATA or NGFF slot. As an example, an SSD has a capacity ranging from 120 GB-1 TB.

While the concepts above have been described with respect to a limited number of embodiments, those skilled in the art will appreciate numerous modifications and variations therefrom. It is intended that the appended claims cover all such modifications and variations as fall within the true spirit and scope of this disclosure.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The following examples pertain to embodiments in accordance with this Specification. Example 1 is an apparatus including: a port to couple to another device over an interconnect, where the port includes circuitry to: identify a receiver usage limit for a given virtual channel of a link to be implemented on the interconnect; generate a link layer packet, where the link layer packet includes a field to indicate the receiver usage limit; and send the link layer packet to the other device over the link.

Example 2 includes the subject matter of example 1, where the given virtual channel includes one of a plurality of virtual channels of the link.

Example 3 includes the subject matter of any one of examples 1-2, where an initial usage limit is set by a transmitter of the other device for the given virtual channel and the receiver usage limit is different from the initial usage limit.

Example 4 includes the subject matter of any one of examples 1-3, where the link layer packet is based on a Peripheral Component Interconnect Express (PCIe)-based protocol.

Example 5 includes the subject matter of any one of examples 1-4, where the link layer packet includes the field, a virtual channel field to identify the given virtual channel to which the receiver usage limit is to apply, and an enable field to identify that usage limit enforcement is enabled for the given virtual channel.

Example 6 includes the subject matter of any one of examples 1-5, where the field indicates one of a defined set of usage limit percentages to be applied as the receiver usage limit.

Example 7 includes the subject matter of example 6, where the packet further includes a usage limit granularity field to adjust a given one of the defined set of usage limit percentages by a granularity to define the receiver usage limit.

Example 8 includes the subject matter of any one of examples 1-7, where the link layer packet is to be sent after the link is brought up.

Example 9 includes the subject matter of example 8, where the link layer packet is to be sent while the link is in an active L0 state.

Example 10 includes the subject matter of any one of examples 1-9, where the circuitry is to identify a change to a virtual channel usage capacity of a receiver for the given virtual channel, and the link layer packet is to be sent based on the change.

Example 11 is an apparatus including: a port to couple to another device over an interconnect, where the port includes circuitry to: identify a first usage limit for a given virtual channel of a link to be implemented on the interconnect; transmit data on the given virtual channel based on the first usage limit; receive, on the link, a data link layer packet (DLLP), where the DLLP includes a field to indicate a second usage limit for the given virtual channel associated with a receiver of the other device; and transmit data on the given virtual channel based on the second usage limit.

Example 12 includes the subject matter of example 11, where the circuitry is further to configure the given virtual channel to change the usage limit for the given virtual channel from the first usage limit to the second usage limit.

Example 13 includes the subject matter of any one of examples 11-12, where the given virtual channel is one of a plurality of virtual channels of the link.

Example 14 includes the subject matter of any one of examples 11-13, where the DLLP is based on a Peripheral Component Interconnect Express (PCIe)-based protocol.

Example 15 includes the subject matter of any one of examples 11-14, where the DLLP includes the field, a virtual channel field to identify the given virtual channel to which the receiver usage limit is to apply, and an enable field to identify that usage limit enforcement is enabled for the given virtual channel.

Example 16 includes the subject matter of any one of examples 11-15, where the field indicates one of a defined set of usage limit percentages to be applied as second usage limit.

Example 17 includes the subject matter of example 16, where the packet further includes a usage limit granularity field to adjust a given one of the defined set of usage limit percentages by a granularity to define the second usage limit.

Example 18 includes the subject matter of any one of examples 11-17, where the DLLP is to be sent after the link is brought up.

Example 19 includes the subject matter of example 18, where the DLLP is to be sent while the link is in an active L0 state.

Example 20 is a method including: identifying a first usage limit for a given virtual channel of a link, where the link connects a first device to a second device on a point-to-point interconnect; causing data to be transmitted on the given virtual channel of link from the first device to the second device based on the first usage limit; receiving, at the first device, a link layer packet from the second device, where the link layer packet includes a field to indicate a second usage limit for the given virtual channel associated with a receiver of the second device; and configuring a transmitter of the first device to transmit data to the second device on the given virtual channel of the link based on the second usage limit.

Example 21 includes the subject matter of example 20, where the circuitry is further to configure the given virtual channel to change the usage limit for the given virtual channel from the first usage limit to the second usage limit.

Example 22 includes the subject matter of any one of examples 20-21, where the given virtual channel is one of a plurality of virtual channels of the link.

Example 23 includes the subject matter of any one of examples 20-22, where the link layer packet is based on a Peripheral Component Interconnect Express (PCIe)-based protocol.

Example 24 includes the subject matter of any one of examples 20-23, where the link layer packet includes the field, a virtual channel field to identify the given virtual channel to which the receiver usage limit is to apply, and an enable field to identify that usage limit enforcement is enabled for the given virtual channel.

Example 25 includes the subject matter of any one of examples 20-24, where the link layer packet is to be sent after the link is brought up.

Example 26 includes the subject matter of example 25, where the link layer packet is to be sent while the link is in an active L0 state.

Example 27 includes the subject matter of any one of examples 20-26, where the field indicates one of a defined set of usage limit percentages to be applied as the second usage limit.

Example 28 includes the subject matter of example 27, where the packet further includes a usage limit granularity field to adjust a given one of the defined set of usage limit percentages by a granularity to define the second usage limit.

Example 29 includes the subject matter of any one of examples 20-28, further including reading a register to identify whether the second device supports dynamic virtual channel usage limit adjustment.

Example 30 is a system including means to perform the method of any one of examples 16-29.

Example 31 is a system including: a first device; and a second device coupled to the first device by an interconnect, where the second device includes a port to couple to the interconnect, and the port includes circuitry to: identify a receiver usage limit for a given virtual channel of a link to be implemented on the interconnect; generate a link layer packet, where the link layer packet includes a field to indicate the receiver usage limit; and send the link layer packet to the other device over the link.

Example 32 includes the subject matter of example 31, where the given virtual channel includes one of a plurality of virtual channels of the link.

Example 33 includes the subject matter of any one of examples 31-32, where an initial usage limit is set by a transmitter of the other device for the given virtual channel and the receiver usage limit is different from the initial usage limit.

Example 34 includes the subject matter of any one of examples 31-33, where the link layer packet is based on a Peripheral Component Interconnect Express (PCIe)-based protocol.

Example 35 includes the subject matter of any one of examples 31-34, where the link layer packet includes the field, a virtual channel field to identify the given virtual channel to which the receiver usage limit is to apply, and an enable field to identify that usage limit enforcement is enabled for the given virtual channel.

Example 36 includes the subject matter of any one of examples 31-35, where the link layer packet is to be sent after the link is brought up.

Example 37 includes the subject matter of example 36, where the link layer packet is to be sent while the link is in an active L0 state.

Example 38 includes the subject matter of any one of examples 31-37, where the circuitry is to identify a change to a virtual channel usage capacity of a receiver for the given virtual channel, and the link layer packet is to be sent based on the change.

Example 39 includes the subject matter of any one of examples 31-38, where the first device includes a first port to couple to the interconnect, and the first port includes circuitry to: identify a first usage limit for the given virtual channel; transmit data on the given virtual channel based on the first usage limit; receive, on the link, the link layer packet; and transmit subsequent data on the given virtual channel based on the second usage limit.

Example 40 includes the subject matter of any one of examples 31-39, further including: system software; and a set of one or more register to be accessed by system software and indicate support of dynamic virtual channel usage limit adjustment by at least one of the first device or the second device.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc, which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
a port to couple to another device over an interconnect, wherein the port comprises circuitry to:
identify a receiver usage limit for a given virtual channel of a link to be implemented on the interconnect;
generate a link layer packet, wherein the link layer packet comprises a field to indicate the receiver usage limit; and
send the link layer packet to the other device over the link.

2. The apparatus of claim 1, wherein the given virtual channel comprises one of a plurality of virtual channels of the link.

3. The apparatus of claim 1, wherein an initial usage limit is set by a transmitter of the other device for the given virtual channel and the receiver usage limit is different from the initial usage limit.

4. The apparatus of claim 1, wherein the link layer packet is based on a Peripheral Component Interconnect Express (PCIe)-based protocol.

5. The apparatus of claim 1, wherein the link layer packet comprises the field, a virtual channel field to identify the given virtual channel to which the receiver usage limit is to apply, and an enable field to identify that usage limit enforcement is enabled for the given virtual channel.

6. The apparatus of claim 1, wherein the link layer packet is to be sent after the link is brought up.

7. The apparatus of claim 6, wherein the link layer packet is to be sent while the link is in an active L0 state.

8. The apparatus of claim 1, wherein the circuitry is to identify a change to a virtual channel usage capacity of a receiver for the given virtual channel, and the link layer packet is to be sent based on the change.

9. An apparatus comprising:
a port to couple to another device over an interconnect, wherein the port comprises circuitry to:
identify a first usage limit for a given virtual channel of a link to be implemented on the interconnect;
transmit data on the given virtual channel based on the first usage limit;
receive, on the link, a data link layer packet (DLLP), wherein the DLLP comprises a field to indicate a second usage limit for the given virtual channel associated with a receiver of the other device; and
transmit data on the given virtual channel based on the second usage limit.

10. The apparatus of claim 9, wherein the circuitry is further to configure the given virtual channel to change the usage limit for the given virtual channel from the first usage limit to the second usage limit.

11. The apparatus of claim 10, wherein the usage limit is to be changed while the link is in an active state.

12. The apparatus of claim 9, wherein the DLLP is based on a Peripheral Component Interconnect Express (PCIe)-based protocol.

13. The apparatus of claim 9, wherein the field indicates one of a defined set of usage limit percentages to be applied as the second usage limit.

14. The apparatus of claim 13, wherein the packet further comprises a usage limit granularity field to adjust a given one of the defined set of usage limit percentages by a granularity to define the second usage limit.

15. A system comprising:
a first device; and
a second device coupled to the first device by an interconnect, wherein the second device comprises a port to couple to the interconnect, and the port comprises circuitry to:
identify a receiver usage limit for a given virtual channel of a link to be implemented on the interconnect;
generate a link layer packet, wherein the link layer packet comprises a field to indicate the receiver usage limit; and
send the link layer packet to the other device over the link.

16. The system of claim 15, wherein an initial usage limit is set by a transmitter of the first device for the given virtual channel and the receiver usage limit is different from the initial usage limit.

17. The system of claim 16, wherein the first device is to adjust usage limit from the initial usage limit to the receiver usage limit based on the link layer packet and while the link is in an active state.

18. The system of claim 15, wherein the link layer packet comprises the field, a virtual channel field to identify the given virtual channel to which the receiver usage limit is to apply, and an enable field to identify that usage limit enforcement is enabled for the given virtual channel.

19. The system of claim 18, wherein the link layer packet further comprises a usage limit granularity field to indicate a usage limit granularity to be applied to the receiver usage limit.

20. The system of claim 15, further comprising:
system software; and
a set of one or more register to be accessed by system software and indicate support of virtual channel usage limit adjustment by at least one of the first device or the second device.
